(19) United States
(12) Patent Application Publication
(10) Pub. No.: US 2023/0178042 A1
(43) Pub. Date: Jun. 8, 2023

(54) GHOST ELIMINATION METHOD, GHOST ELIMINATION DEVICE AND DISPLAY PANEL

(71) Applicants: Beijing BOE Display Technology Co., Ltd., Beijing (CN); BOE Technology Group Co., Ltd., Beijing (CN)

(72) Inventors: Guohuo SU, Beijing (CN); Zhihua SUN, Beijing (CN); Senwang LI, Beijing (CN); Zhun LIN, Beijing (CN)

(21) Appl. No.: 17/799,798

(22) PCT Filed: Jul. 6, 2021
(86) PCT No.: PCT/CN2021/104721

§ 371 Date: Aug. 15, 2022

(30) Foreign Application Priority Data
Aug. 24, 2020 (CN) 202010857139.3

(51) Int. Cl. G09G 3/36

(52) U.S. Cl. CPC G09G 3/36; G09G 2320/0257

(57) ABSTRACT

A ghost elimination method, a ghost elimination device and a display panel are provided. The ghost elimination method includes driving and displaying a display panel by taking a plurality of continuous frames of pictures as a period. In one period, motion compensation is performed on the front m frames of pictures, and the motion compensation is not performed on the remaining n frames of pictures, where m and n are both positive integers.

### CROSS-REFERENCE TO RELATED APPLICATION

This application claims a priority of the Chinese patent application No. 202010857139.3 filed on Aug. 24, 2020, which is incorporated herein by reference in its entirety.

### TECHNICAL FIELD

The present disclosure relates to the field of display technology, in particular to a ghost elimination method, a ghost elimination device and a display panel.

### BACKGROUND

At present, in a process of displaying an image on a display panel, if a size of an image content is smaller than a size of the display panel, black borders appear at a region of the display panel where the image content is not displayed, and the black borders are generally arranged above and below the image content. Due to a scanning signal being scanned row by row from top to bottom, there are jitters in a boundary region between the image content and the black border below the image content, i.e., data compensation at the boundary region is irregular. After a certain period of time, ghosts appears at the boundary region, resulting in poor display.

### SUMMARY

An object of the present disclosure is to provide a ghost elimination method, a ghost elimination device and a display panel.

The present disclosure provides the following technical solutions.

In one aspect, the present disclosure provides in some embodiments a ghost elimination method, including driving and displaying a display panel by taking a plurality of continuous frames of pictures as a period. In one period, motion compensation is performed on the front m frames of pictures, and the motion compensation is not performed on the remaining n frames of pictures, where m and n are both positive integers.

Optionally, a ratio of n: m ranges from 0.12 to 0.25.

Optionally, a value of m ranges from 40 to 50, and a value of n ranges from 6 to 10.

Optionally, a value of m is 40, and a value of n is 8.

Optionally, the display panel is a liquid crystal display panel.

In another aspect, the present disclosure provides in some embodiments a ghost elimination device, including an elimination module, configured to drive and display a display panel by taking a plurality of continuous frames of pictures as a period. In one period, motion compensation is performed on the front m frames of pictures, and the motion compensation is not performed on the remaining n frames of pictures, where m and n are both positive integers.

Optionally, a ratio of n: m ranges from 0.12 to 0.25.

Optionally, a value of m ranges from 40 to 50, and a value of n ranges from 6 to 10.

Optionally, a value of m is 40, and a value of n is 8.

In yet another aspect, the present disclosure provides in some embodiments a display panel, including the above-mentioned ghost elimination device.

Optionally, the display panel is a liquid crystal display panel.

In still yet another aspect, the present disclosure provides in some embodiments a readable storage medium storing therein a program or instruction, the program or instruction is executed by a processor so as to implement the steps in the above-mentioned ghost elimination method.

### BRIEF DESCRIPTION OF THE DRAWINGS

FIG. 1 is a schematic view showing a display region of a display panel according to one embodiment of the present disclosure;

FIG. 2 is a flow chart of a ghost elimination method according to one embodiment of the present disclosure;

FIG. 3 is a schematic view showing a driving voltage according to one embodiment of the present disclosure;

FIG. 4 is a schematic view showing an equivalent bias voltage according to one embodiment of the present disclosure;

FIG. 5 is a schematic view showing a pixel capacitor according to one embodiment of the present disclosure;

FIG. 6 is a schematic view showing a principle of self-balancing of a pixel electric field according to one embodiment of the present disclosure; and

FIG. 7 is a schematic view showing a ghost elimination device according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

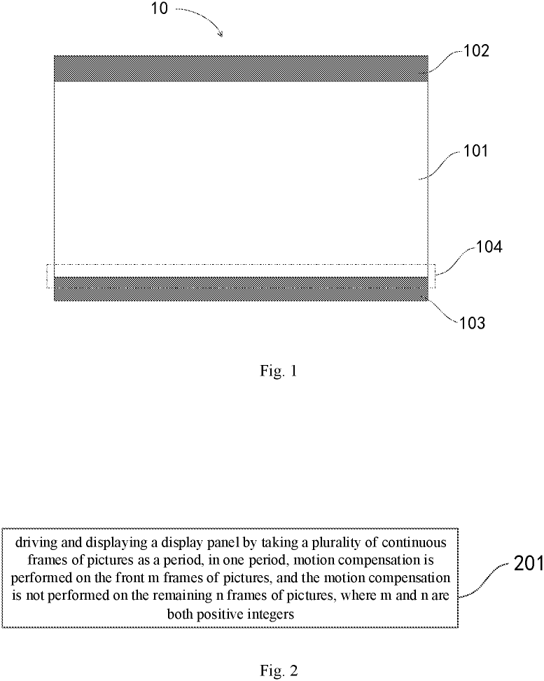

FIG. 1 is a schematic view showing a display region of a display panel in the embodiments of the present disclosure. As shown in FIG. 1, in a process of displaying an image on a display panel 10, for example, when a display panel with a size of 16:9 is used to display a movie source with an image size of 21:9, due to a size of an image content being smaller than a size of the display panel, a display interface of the display panel 10 is generally divided into a normal display region 101, a first black border 102 arranged above the normal display region 101, and a second black border 103 arranged below the normal displaying region 101, i.e., the normal displaying region 101 normally displays the image content, the first black border 102 and the second black border 103 are displayed in black. Due to a scanning signal being scanned row by row from top to bottom, when the motion compensation is performed on a driving chip, an initial compensation position is a boundary region between the first black border 102 and the normal display region 101, and the boundary region is stable and has no ghost; subsequence to the motion compensation being performed on the picture in the normal display region 101, a boundary region 104 between the normal display region 101 and the second black border 103 arranged below the normal display region 101 may be unstable due to the a compensation algorithm, and resulting in jitter; and subsequence to the motion compensation, there is a certain degree of bias in the data, which is specifically manifested by the bias of the driving voltage. After a certain period of accumulation, there is a bias voltage in the pixels in the boundary region 104, thereby to produce ghosts and result in poor display.

FIG. 2 is a flow chart of a ghost elimination method in the embodiments of the present disclosure, the ghost elimination method includes the following step.

Step 201: driving and displaying a display panel by taking a plurality of continuous frames of pictures as a period. In one period, motion compensation is performed on the front m frames of pictures, and the motion compensation is not performed on the remaining n frames of pictures, where m and n are both positive integers.

In the embodiments of the present disclosure, one period includes m + n frames of pictures, the motion compensation is performed on the front m frames of pictures, and subsequence to the motion compensation being enabled, a positive compensation voltage is not equal to a negative compensation voltage, and a certain bias voltage is accumulated. For the remaining n frames of pictures, the motion compensation is not performed, so as to, in the remaining n frames of pictures, enable the positive compensation voltage to be equal to the negative compensation voltage through a self-recovery function of a pixel capacitance electric field and realize the equivalent bias voltage being almost zero, thereby to weaken or even eliminate ghosts, where m and n are both positive integers, and m is generally greater than n.

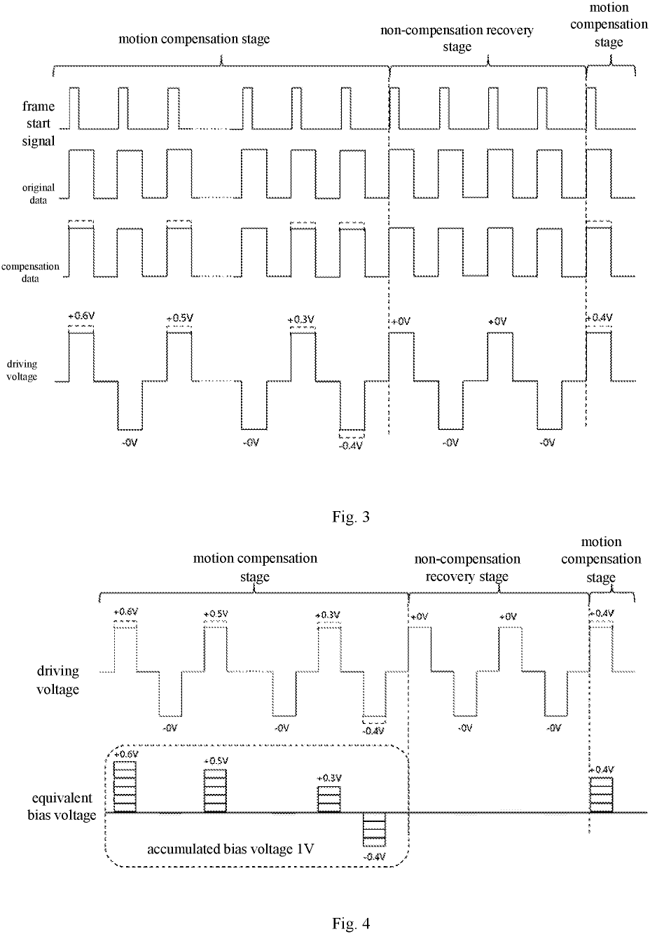

FIG. 3 is a schematic view showing a driving voltage in the embodiments of the present disclosure. As shown in FIG. 3, a frame start signal controls the start time of each frame. Generally, the time to display 60 frames of pictures is 1 second; the original data is the initial data received by a System-On-a-Chip (SOC) main board, and the original data is merely represented as a binary value of 0 or 1, and does not represent the positive or negative polarity of the voltage. Subsequence to the motion compensation being performed by the SOC main board, the actual value of compensation data is shown in the line corresponding to the compensation data in FIG. 3. It can be seen that, when the motion compensation is performed, the value of part of the data is increased (as shown by the dotted line), and when the motion compensation is not performed, the value is not changed. When the compensation data is transmitted to the driving chip, it will be converted into the positive analog voltage value and negative analog voltage value for liquid crystal driving, i.e., the driving voltage. It can be seen that, after the motion compensation is performed, the driving voltage has positive voltage compensation and negative voltage compensation, while the frame without motion compensation has no voltage compensation. In the boundary region 104, the motion compensation jitters to the second black border 103, and the positive voltage compensation is greater than the negative voltage compensation. As shown in FIG. 3, the positive voltage compensation is +0.6 V, +0.5 V, and +0.3 V, and the negative voltage compensation is -0.4 V. The positive compensation voltage is not equal to the negative compensation voltage, resulting in a voltage bias. In the existing art, motion compensation is always performed by the SOC main board, and the positive compensation voltage is always not equal to the negative compensation voltage, after a certain period of accumulation, the bias voltage is generated, and the bias voltage causes the generation of ghosts. However, in the embodiments of the present disclosure, the motion compensation is performed on the front m frames of pictures, and the motion compensation is not performed on the remaining n frames of pictures. At the stage of not performing the motion compensation, there is no positive voltage compensation and negative voltage compensation, and the driving voltage is balanced, thereby to forcibly weaken the accumulated bias voltage, and achieve the effect of weakening or even eliminating the ghosts.

FIG. 4 is a schematic view showing an equivalent bias voltage in the embodiments of the present disclosure. As shown in FIG. 3, the boundary region 104 in FIG. 1 is taken as an example to analyze the equivalent bias voltage: in a motion compensation stage, the bias voltage accumulated after the corresponding time in the motion compensation stage is 1 V by adding the positive compensation voltage and the negative compensation voltage of the driving voltage, and when the display pixel has the bias voltage, it results in poor display will lead to poor display, that is, ghosts is generated. However, in the embodiments of the present disclosure, the remaining n frames are set not to be subjected to motion compensation, and in a non-motion compensation stage, positive voltage and negative voltage appear in pairs, and there is no positive voltage compensation and negative voltage compensation, so that the positive voltage and the negative voltage may be offset with each other, thereby to weaken or even eliminate ghosts through the self-recovery function of the pixel capacitance electric field.

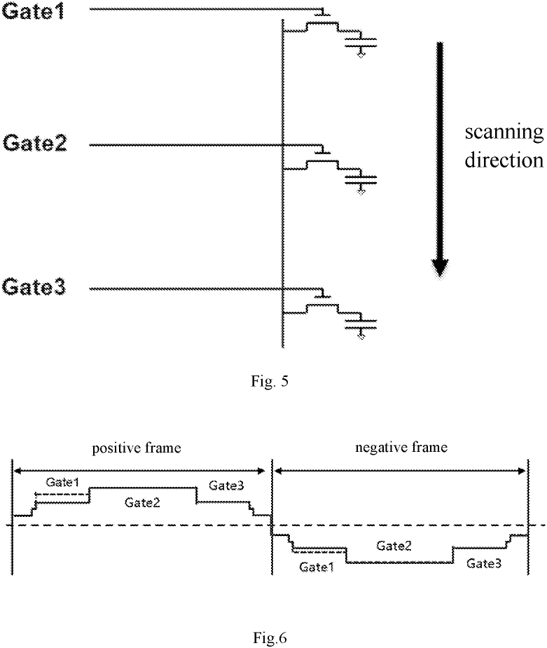

FIG. 5 is a schematic view showing a pixel capacitor in the embodiments of the present disclosure, and FIG. 6 is a schematic view showing a principle of self-balancing of a pixel electric field in the embodiments of the present disclosure. As shown in FIG. 5, three rows of pixels are shown in the figure, each of the three rows of pixels corresponds to a row of pixel capacitors, and the three rows of pixels are charged by the driving voltage in FIG. 4. As shown in FIG. 6, the short dashed line indicates that the pixels corresponding to the row Gate1 have the motion compensation, i.e., the pixels have the positive compensation voltage and the negative compensation voltage. If the positive compensation voltage and the negative compensation voltage of the same row (i.e., Gate1) in two frames are added, they may not be offset, and the ghosts are generated, and this corresponds to the motion compensation stage. In the pixel capacitance electric fields corresponding to the row Gate2 and the row Gate3, there is no positive compensation voltage and negative compensation voltage, and the value of the positive driving voltage is equal to the value of the negative driving voltages, the pixel capacitance electric field is in a balanced state, so it is not easy to generate the ghosts, and this corresponds to a non-motion compensation stage. In this regard, for the pixels in a same row, the bias voltage is generated due to the motion compensation in the process of displaying the front m frames of pictures, the motion compensation is not performed on the remaining n frames of pictures, so that the positive and negative driving voltages are symmetrically balanced, thereby to forcibly weaken the accumulated bias voltage, and achieve the effect of weakening or even eliminating the ghosts.

In the embodiments of the present disclosure, a ratio of n: m ranges from 0.12 to 0.25, i.e., in one period, the ratio of the quantity of frames n for which the motion compensation is not performed on the quantity of frames m for which the motion compensation is performed ranges from 0.12 to 0.25. By setting the above proportion, in one period, a small amount of bias voltage is accumulated after the time of m frames is controlled, the motion compensation is not performed on the remaining n frames, and the bias voltage is forced to perform self-recovery in the time of n frames, so as to effectively reduce or even eliminate the accumulated bias voltage and weaken or even eliminate the ghosts, thereby to reduce the redundancy of a certain video sequence, and reduce the operation power consumption. Subsequently, a periodic period control is carried out in accordance with the frame quantity proportion of the above proportion, so as to make the ghosts almost or even completely disappear.

In the embodiments of the present disclosure, a value of m ranges from 40 to 50, and a value of n ranges from 6 to 10, i.e., in one period, the quantity of frames for which the motion compensation is performed is 40 to 50 frames, and the quantity of frames for which the motion compensation is not performed is 6 to 10 frames. In the above value range of m and n, the redundancy of a certain video sequence and the operation power consumption are both reduced, and the bias voltage accumulated in the motion compensation stage is less; and in the non-motion compensation stage, the reduction of the bias voltage have a good recovery effect, thereby to reduce or even eliminate the ghosts. Optionally, when the value of m is 40 and the value of n is 8, the ghost elimination effect is the best.

In the embodiments of the present disclosure, the display panel is a liquid crystal display panel, i.e., Liquid Crystal Display (LCD).

According to the ghost elimination method in the embodiments of the present disclosure, after the motion compensation is performed on a certain quantity of frames, the motion compensation is further closed in a plurality of subsequent frames, and the bias voltage of a pixel is self-recovered through the self-recovery characteristic of a capacitance electric field, so as to weaken or even eliminate the bias voltage accumulated by the pixel, thereby to achieve the effect of weakening or even eliminating the ghosts.

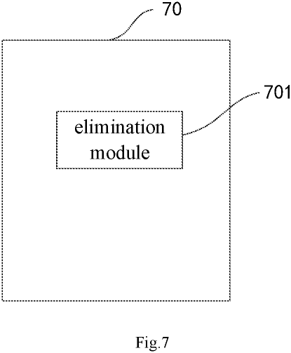

FIG. 7 is a schematic view showing a ghost elimination device in the embodiments of the present disclosure. As shown in FIG. 7, the present disclosure further provides in some embodiments a ghost elimination device 90, including an elimination module 701, configured to drive and display a display panel by taking a plurality of continuous frames of pictures as a period. In one period, motion compensation is performed on the front m frames of pictures, and the motion compensation is not performed on the remaining n frames of pictures, where m and n are both positive integers.

According to the ghost elimination device in the embodiments of the present disclosure, after the motion compensation is performed on a certain quantity of frames, the motion compensation is further closed in the plurality of subsequent frames, and the bias voltage of a pixel is self-recovered through the self-recovery characteristic of a capacitance electric field, so as to weaken or even eliminate the bias voltage accumulated by the pixel, thereby to achieve the effect of weakening or even eliminating the ghosts.

In the embodiments of the present disclosure, a ratio of n: m ranges from 0.12 to 0.25.

In the embodiments of the present disclosure, a value of m ranges from 40 to 50, and a value of n ranges from 6 to 10.

In the embodiments of the present disclosure, a value of m is 40, and a value of n is 8.

In the embodiments of the present disclosure, the display panel is a liquid crystal display panel, i.e., LCD.

The embodiment of the present disclosure is an embodiment of a device corresponding to the above ghost elimination method in the embodiments of the present disclosure. The ghost elimination device in the embodiments of the present disclosure may implement the steps in the above-mentioned ghost elimination method with a same technical effect, which will not be particularly defined herein.

The present disclosure further provides in some embodiments a display panel, including the above-mentioned ghost elimination device. Due to the ghost elimination device may further close the motion compensation in the plurality of subsequent frames after the motion compensation is performed on a certain quantity of frames, and the bias voltage of a pixel is self-recovered through the self-recovery characteristic of a capacitance electric field, so as to weaken or even eliminate the bias voltage accumulated by the pixel, thereby to achieve the effect of weakening or even eliminating the ghosts. In this regard, the display panel in the embodiments of the present disclosure also has the above technical effects, which will not be particularly defined herein.

In the embodiments of the present disclosure, the display panel is a liquid crystal display panel, i.e., LCD.

The present disclosure further provides in some embodiments a readable storage medium storing therein a program or instruction, the program or instruction is executed by a processor so as to implement the steps in the above-mentioned ghost elimination method with a same technical effect, which will not be particularly defined herein.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A ghost elimination method, comprising: driving and displaying a display panel by taking a plurality of continuous frames of pictures as a period, wherein in one period, a motion compensation is performed on front m frames of pictures, and the motion compensation is not performed on remaining n frames of pictures, wherein m and n are both positive integers.

2. The ghost elimination method according to claim 1, wherein a ratio of n: m ranges from 0.12 to 0.25.

3. The ghost elimination method according to claim 2, wherein a value of m ranges from 40 to 50, and a value of n ranges from 6 to 10.

4. The ghost elimination method according to claim 3, wherein a value of m is 40, and a value of n is 8.

5. The ghost elimination method according to claim 1, wherein the display panel is a liquid crystal display panel.

6. A ghost elimination device, comprising: an elimination module, configured to drive and display a display panel by taking a plurality of continuous frames of pictures as a period, wherein in one period, motion compensation is performed on the front m frames of pictures, and the motion compensation is not performed on the remaining n frames of pictures, wherein m and n are both positive integers.

7. The ghost elimination device according to claim 6, wherein a ratio of n: m ranges from 0.12 to 0.25.

8. The ghost elimination device according to claim 7, wherein a value of m ranges from 40 to 50, and a value of n ranges from 6 to 10.

9. The ghost elimination device according to claim 8, wherein a value of m is 40, and a value of n is 8.

10. A display panel, comprising the ghost elimination device according to claim 6.

11. The display panel according to claim 10, wherein the display panel is a liquid crystal display panel.

12. A readable storage medium storing therein a program or instruction, wherein the program or instruction is executed by a processor to perform the steps in the ghost elimination method according to claim 1.
